(19) United States
(12) Patent Application Publication
(10) Pub. No.: US 2008/0171128 A1
(43) Pub. Date: Jul. 17, 2008

(54) STORAGE STABLE CREME FILLING FORTIFIED WITH OMEGA-3 FATTY ACIDS

(76) Inventors: Gloria Cagampang, Battle Creek, MI (US); Lisa Elander, Kalamazoo, MI (US); Anthony Bello, Battle Creek, MI (US)

Correspondence Address: Randall L. Shoemaker;Dickinson Wright PLLC, Ste. 2000, 38525 Woodward Ave., Bloomfield Hills, MI, 48304-2970, US

(21) Appl. No.: 11/972,835

(22) Filed: Jan. 11, 2008

Related U.S. Application Data
(60) Provisional application No. 60/884,439, filed on Jan. 11, 2007.

(51) Int. Cl. A23G 3/40

(52) U.S. Cl. 426/660; 426/519

(57) ABSTRACT

Disclosed is a crème filling that is fortified with the omega-3 fatty acids eicosapentaenoic acid, docosahexaenoic acid, or a mixture thereof and is room temperature stable for at least 4 months and more preferably for at least 8 months. It has been found that these omega-3 fatty acids can be stabilized by using in the crème filling a stabilizer fat and/or oil having a high saturated fat level of from 30 to 55%. The crème filling finds wide use in a variety of food products and provides the health benefits of omega-3 fatty acids to these foods.

### RELATED APPLICATIONS

This application claims the benefit of U.S. Provisional Application No. 60/884,439, filed Jan. 11, 2007.

### STATEMENT REGARDING FEDERALLY SPONSORED RESEARCH

NONE

### TECHNICAL FIELD

This invention relates generally to crème fillings for food products and, more particularly, to room temperature storage stable crème fillings fortified with omega-3 fatty acids for use in food products such as baked goods.

### BACKGROUND OF THE INVENTION

Long chain polyunsaturated omega-3 fatty acids from marine sources have been shown to be beneficial to human health. The long chain polyunsaturated fatty acids of primary interest are eicosapentaenoic acid (EPA) (20:5w-3), and docosahexaenoic acid (DHA) (22:6w-3). The health benefits associated with enhanced consumption of these omega-3 fatty acids include a lowering of serum cholesterol, reduction of blood pressure, reduction of the risk of heart disease, and a reduction of the risk of stroke. These omega-3 fatty acids are also essential to normal neuronal development and their depletion has been associated with neurodegenerative diseases such as Alzheimer's disease. In the human eye and retina the ratio of DHA:EPA is 5:1 and their presence is essential for normal eye development. The fatty acid DHA is also believed to be essential for optimal cognitive development in infants. Food fortified with DHA is often called “brain food” in Asian countries. Preliminary studies suggest that long chain polyunsaturated omega-3 fatty acids may play a role in mediating chronic inflammatory assaults and use of them by individuals with mild asthma is documented to reduce the severity of the histamine response in asthmatics.

There are several main sources of these beneficial long chain polyunsaturated omega-3 fatty acids. Marine animals, such as fish and crustaceans, and marine plants, such as micro algae, are the main sources of DHA and EPA. In particular, fatty fish such as mackerel and salmon contain high levels of DHA and EPA. Marine micro algae contain predominantly DHA. Marine micro algae have an advantage as a source of DHA in that large volumes can be rapidly produced using modern methods and there is no need for the extensive acreage associated with fish farms or the difficulty of fishing. The omega-3 fatty acids are generally found in the form of triglycerides, i.e. one or more of the fatty acids connected to the glycerol backbone is an omega-3 fatty acid, and not in the form of free fatty acids. Both forms have the health benefits and the problems of oxidative instability. Therefore in this specification and the associated claims no distinction will be made between these two forms of omega-3 fatty acids. The term omega-3 fatty acid refers to both the free fatty acid form and the triglyceride form unless specifically noted otherwise.

The beneficial health effects of the omega-3 fatty acids EPA and DHA, require relatively large amounts of the omega-3 fatty acids making it impractical to obtain the recommended daily amount by consuming fish alone. Thus, both EPA and DHA have been packaged together in caplet form. Consumers do not enjoy consuming the caplets because they are large and hard to swallow and the caplets can quickly develop an unpleasant fishy aroma and taste. Prior attempts to add DHA and/or EPA directly to food products have been unsuccessful because the unstable omega-3 fatty acids rapidly give rise to a fishy taste and aroma in the food product and make it unpalatable. It is believed that DHA and EPA are particularly unstable in the presence of water and high heat, this further complicates their use in food products. Unlike other fatty acids these omega-3 fatty acids can not be stabilized in foods merely by adding the typical antioxidants to the foods. Past attempts to create food products with EPA and/or DHA have been largely unsuccessful. Most of these food products suffer from very short term stability, even when stored frozen or refrigerated.

It is desirable to provide a typical crème filling that is fortified with EPA and/or DHA and that is stable at room temperature for extended periods of time. Such a crème filling could find widespread use in the food industry to enhance the heath benefits of a wide range of foods including baked goods, such as cookies, filled or layered granola bars, candies and other snacking foods.

### SUMMARY OF THE INVENTION

In general terms, this invention provides a crème filling comprising sweetener present in an amount of from 35 to 90% by weight, a stabilizer fat or fat blend having a saturated fat level of from 30 to 55% and present in an amount of from 10 to 35% by weight, at least one of the omega-3 fatty acids eicosapentaenoic acid or docosahexaenoic acid, and preferably an emulsifier. The crème filling finds widespread use in the food industry to enhance the heath benefits of a wide range of foods including baked goods, such as cookies, filled or layered granola bars, candies and other snacking foods.

These and other features and advantages of this invention will become more apparent to those skilled in the art from the detailed description of a preferred embodiment. The drawings that accompany the detailed description are described below.

### DETAILED DESCRIPTION OF A PREFERRED EMBODIMENT

As discussed above marine animals and marine plants are the main sources of EPA and DHA fatty acids. The use of fish oils as a source of EPA and DHA is well known, many commercial sources are available and all are useful in the present application. Recently, a number of manufacturers have developed processes for growing marine micro algae with high efficiency. These micro algae are a great source of EPA and DHA at very high yields in a completely renewable process. Such micro algae derived EPA and DHA are available from a number of sources. One source of micro algae derived EPA and DHA is Martek Biosciences Corporation, Columbia, Md., USA. A second source of micro algae derived EPA and DHA is Nutrinova Nutrition Specialties and Food Ingredients, DE. The omega-3 fatty acids from micro algae are available either as free flowing powders or as an oil mixture. When creating a free flowing powder, the omega-3 fatty acids are typically plated onto bulking agents such as corn syrup solids, mannitol, calcium carbonate, whey protein isolate, gluten, pregelatinized starches, cellulose fiber, carbohydrates, gelatin, flour, grain, bran, freeze dried whole fruits, fruit powders, and combinations thereof. The plated powders are then spray dried to form a free flowing powder. One such algae source is designated as Martek DHA™ HM by Martek Biosciences Corp. This source was used in the experiments described below. The Martek DHA™ HM source has a level of DHA of from 300 to 350 milligrams of DHA per gram of oil. The EPA levels are much lower and on the order of 10 to 15 milligrams of EPA per gram of oil. Either form, oil or powder, and any source of DHA or EPA is useful in the present invention and, unless specifically noted, no distinction will be made in the present specification or claims between the two physical forms. In addition, the omega-3 fatty acids in each form are available as either the free fatty acids or in the triglyceride form. Generally, the triglyceride form is more stable and in the present specification and claims there will be no distinction made between whether the fatty acids are in the free form or as part of a triglyceride.

Crème fillings generally comprise a mixture of sucrose or other sugars, flavorings and oils or fats. In the present specification and claims the term fat and oil are used interchangeably unless otherwise indicated. The fat or oil may be a liquid at room temperature, a semi-solid or a solid. In addition, a fat or an oil may be a mixture of two or more fats or oils. The sucrose and other sweeteners can include nutritive sweeteners and non-nutritive sweeteners. The formula can also include emulsifiers. The oil and fats provide the crème filling with the ability to retain whipped in air to make the crème filling light and fluffy. Texture and flavor are what consumers desire in crème fillings. To be useful in consumer food products the crème fillings need to be stable at room temperature for extended periods of time in excess of 4 months, preferably for at least 6 months and most preferably for at least 8 months.

The nutritive sweeteners that can be used in the present invention, only by way of example, comprise sucrose, confectioner's sugar, glucose, dextrose, fructose, crystalline fructose, lactose, malt syrup, malt syrup solids, rice syrup solids, rice syrup, sorghum syrup, invert sugar, refiners syrup, corn syrup, corn syrup solids, maltose, high fructose corn syrup, honey, molasses, maltodextrin or combinations thereof. In addition, non-nutritive artificial sweeteners can also be used as part of the sweetener, examples include acesulfame K, aspartame, sucralose, d-tagatose, and combinations thereof. Preferably, the sweetener level in the present crème filling is from 35 to 90% by weight and more preferably from 40 to 85% by weight based on the total weight of the crème filling.

The crème filling may also include any desired flavors such as, by way of example only, chocolate, cocoa, light Dutch cocoa, vanilla, almond, lemon, combinations thereof and any other desired flavor. Flavors are typically used in amounts of from 0.02% to 5% by weight based on the total weight of the crème filling. Typically, the crème filling will also include some salt, such as flour salt, at a level of from about 0.5 to 0.01% by weight. Other optional components include emulsifiers such as, by way of example only, lecithin, monoglycerides, diglycerides, polysorbates, or mixtures thereof. Emulsifiers are typically used at levels of from 0.05 to 2.0% by weight based on the total weight of the crème.

A surprising discovery of the present invention is that the composition of the main fat or oil used in the crème filling can dramatically effect the stability of the added omega-3 fatty acids EPA and DHA. As disclosed in the experiments described below when using a typical crème oil, canola oil, to form the crème filling the addition of EPA and DHA caused a fishy odor to develop quickly in the crème filling. The crème filling formed using canola oil was not stable for 24 hours at room temperature. The canola oil had a saturated fat content of 6% by weight. Throughout the present specification and claims a formulation is described as stable if a trained food panelist can not detect a marine or fishy aroma or taste in a sample at the given time point. A sample is unstable once a marine or fishy aroma or taste is detectable by the trained panelist. Such trained food panelists typically can detect such off odors and tastes even before a consumer would detect it. Consumers will not accept crème fillings that exhibit any sort of marine or fishy aroma or taste. Surprisingly, it was discovered that EPA and DHA could be stabilized by the use of stabilizer fats and oils that had a saturated fat content of from 30 to 55% by weight and more preferably from 33 to 50% by weight, and most preferably from 33 to 45% by weight based on the total weigh of the fat or blend of fats. The stabilizer fat can comprise either a single oil or a blend of oils or fats so long as the fat or blend has a saturated fat level of from 30 to 55% by weight based on the total weight of the fat or blend. Examples of two of these stabilizer oils or fats include an oil comprising a mixture of approximately 77% low linoleic acid soybean oil and approximately 23% of a hardstock formed from palm kernel oil and interesterified palm oil. This oil is designated as LLSPA in Table 1 below and has a 33% saturated fat level. Another example of a useful stabilizer oil is a pure palm oil having a saturated fat content of 55% by weight. All of the oils used in the experiments described below had a trans-fat level of 1% by weight or less. Preferably the stabilizer fat used in the present invention has a trans-fat level of 1% by weight or less. The components for the stability experiments were as described below in Table 1 and were mixed in the order of the listing in Table 1 and as described. The EPA/DHA source was Martek DHA™ HM from Martek and it was in the form of an oil. All mixing was conducted in a 20 quart Hobart mixer with a flat paddle. The mixing all occurred at room temperature and care was taken to ensure that the crème did not exceed a temperature of from 70 to 85° F., more preferably from 75 to 80° F.

TABLE 1

| Component/Process | | | |
|---|---|---|---|
| step | Crème 1 | Crème 2 | Crème 3 |
| Oil | 22.75% by weight | 22.75% by weight | 22.75% by weight |
| | Canola oil, (6% | LLSPA oil, (33% | Palm oil, (55% |
| | saturated fat) | saturated fat) | saturated fat) |
| EPA/DHA oil | 0.37% by weight | 0.37% by weight | 0.37% by weight |
| | Mix for 1 minute on | Mix for 1 minute on | Mix for 1 minute on |
| | high speed setting 3 | high speed setting 3 | high speed setting 3 |
| Emulsifier | 0.11% by weight | 0.11% by weight | 0.11% by weight |
| | lecithin | lecithin | lecithin |
| Salt | 0.07% by weight | 0.07% by weight | 0.07% by weight |
| | flour salt | flour salt | flour salt |
| | Mix for 3 minutes on | Mix for 3 minutes on | Mix for 3 minutes on |
| | low speed setting 1 | low speed setting 1 | low speed setting 1 |
| Sweetener | 20.58% by weight | 20.58% by weight | 20.58% by weight |
| | dextrose | dextrose | dextrose |
| Sweetener | 56.12% by weight | 56.12% by weight | 56.12% by weight |
| | 6X powdered sugar | 6X powdered sugar | 6X powdered sugar |
| | Mix for 7-9 minutes | Mix for 7-9 minutes | Mix for 7-9 minutes |
| | at setting 2 | at setting 2 | at setting 2 |

The formed crèmes 1-3 were each then placed between two cookie base layers to form a filled cookie sandwich. A plurality of filled cookies made from each crème filling were packaged in industry standard sealed packages and placed into storage at 70° F. and 35% relative humidity for long term stability studies. A group of trained panelists also examined the filled cookie sandwiches from each crème within 24 hours after preparation. It was found that the filled cookie sandwiches prepared using crème 1 were all unstable, even over the first 24 hours. All of these samples exhibited a fishy marine aroma within 24 hours of preparation that was strong and would be unacceptable to consumers. Filled cookie sandwiches prepared with either crème 2 or crème 3 were stable at the first time point of within 24 hours. Additionally, the samples prepared from crème 2 or crème 3 were found to be stable when tested after 2, 4, 6 and 8 months of storage at 70° F. and 35% relative humidity. None of the samples exhibited any fishy or marine aroma. This is a dramatic difference from the results obtained using the canola oil in crème formula 1. Samples prepared with crème 3 did tend to exhibit very small waxy particles in them not found in crème 2. Surprisingly, neither crème filling 2 or 3 required the use of any gelling agents, as is often found in crème fillings, for stability or ability to hold whipped in air. Creme fillings have been made using a level of from 1 to 13 milligrams of DHA/EPA per gram of crème filling and these levels are the preferred levels in the crème filling and are stable for at least 8 months under the described storage conditions. Preferably the DHA/EPA is added at a level to the crème filling so as to provide from 10 to 500 mg of DHA/EPA per serving of final food product. In the case of a typical crème filled cookie an average serving size is 30 grams and the filling comprises 30% by weight of the cookie so the DHA/EPA amount can be adjusted to provide the desired level of 10 to 500 milligrams of DHA/EPA per serving. Preferably the stabilizer oil and/or fat is present in the crème filling in an amount of from 10 to 35% and more preferably from 15 to 30% by weight and most preferably from 20 to 30% by weight based on the total weight of the crème filling.

It was also found that the addition of the EPA/DHA to the crème filling needs to occur, as in Table 1, in the first step of the crème formation for optimal stability. That is the EPA/DHA must initially be creamed with the stabilizer fat prior to additional processing steps. When the experiment described above was repeated except that the EPA/DHA addition was made with the dextrose and powdered sugar the resulting crème fillings were not stable. Adding the omega-3 fatty acids at the end of the process resulted in the crème filling being unstable within 24 hours, even when the saturated fat level of the stabilizer oil was 33% or 55%. These results demonstrate that it is a combination of the time of addition and the use of stabilizer oils having saturated fat levels of from 30 to 55% that results in a room temperature storage stable crème filling fortified with EPA/DHA. The current process and formula can be used to form a room temperature stable crème filling that is fortified with high levels of EPA and/or DHA. It is preferable that the crème filling be fortified to a level such that a serving of the final food product provides from 10 to 500 milligrams of EPA and/or DHA.

If desired, the crème filling may also include typical anti-oxidants although experience has shown that these alone are not sufficient to stabilize the omega-3 fatty acids during storage. Such anti-oxidants include, by way of example only: tocopherols, ascorbic acid, ascorbyl palmitate, rosemary extract, butylated hydroxytoluene, butylated hydroxyanisol, tert-butyl-1,4-benzenediol, citric acid, or combinations thereof.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A crème filling comprising sweetener present in an amount of from 35 to 90% by weight, a stabilizer fat having a saturated fat level of from 30 to 55% and present in an amount of from 10 to 35% by weight, and at least one omega-3 fatty acid comprising eicosapentaenoic acid, docosahexaenoic acid, or a mixture thereof.

2. A crème filling as recited in claim 1 wherein said crème filling is stable without development of fishy aroma or taste for at least 3 months during storage at 70° F.

3. A crème filling as recited in claim 1 wherein said crème filling is stable without development of fishy aroma or taste for at least 6 months during storage at 70° F.

4. A crème filling as recited in claim 1 wherein said crème filling is stable without development of fishy aroma or taste for at least 8 months during storage at 70° F.

5. A crème filling as recited in claim 1 wherein said crème filling comprises 40 to 85% by weight of sweetener.

6. A crème filling as recited in claim 1 wherein said sweetener comprises sucrose, confectioner's sugar, glucose, dextrose, fructose, crystalline fructose, lactose, malt syrup, malt syrup solids, rice syrup solids, rice syrup, sorghum syrup, invert sugar, refiners syrup, corn syrup, corn syrup solids, maltose, high fructose corn syrup, honey, molasses, maltodextrin or combinations thereof.

7. A crème filling as recited in claim 6 wherein said sweetener further comprises a non-nutritive sweetener.

8. A crème filling as recited in claim 1 wherein said crème filling comprises a stabilizer fat having a saturated fat level of from 33 to 50% by weight.

9. A crème filling as recited in claim 1 wherein said crème filling comprises a stabilizer fat having a saturated fat level of from 33 to 45% by weight.

10. A crème filling as recited in claim 1 wherein said crème filling comprises a stabilizer fat present at a level of from 15 to 30% by weight.

11. A crème filling as recited in claim 1 wherein said crème filling further comprises an emulsifier present at a level of from 0.05 to 2.0% by weight based on the total weight.

12. A crème filling as recited in claim 11 wherein said emulsifier comprises lecithin, a monoglyceride, a diglyceride, a polysorbate, or mixtures thereof.

13. A crème filling as recited in claim 1 wherein said stabilizer fat has a trans-fat content of 1% or less.

14. A crème filling as recited in claim 1 wherein said crème filling comprises from 1 to 13 milligrams of DHA, or 1 to 13 milligrams of EPA, or 1 to 13 milligrams of both EPA and DHA per gram of crème filling.

15. A process for preparation of a crème filling comprising the steps of:
a) creaming at least one omega-3 fatty acid comprising eicosapentaenoic acid, docosahexaenoic acid, or a mixture thereof with a stabilizer fat having a saturated fat level of from 30 to 55% by weight;
b) adding sweetener to the creamed stabilizer fat and omega-3 fatty acid mixture in an amount of from 35 to 90% by weight based on the total weight of the crème filling and mixing until homogeneous thereby forming the crème filling.

16. The process as recited in claim 15 wherein step a) comprises creaming with a stabilizing fat having a saturated fat level of from 33 to 50% by weight.

17. The process as recited in claim 15 wherein step a) comprises creaming with a stabilizing fat having a saturated fat level of from 33 to 45% by weight.

18. The process as recited in claim 15 wherein step a) comprises creaming with a stabilizing fat wherein the stabilizing fat is present in an amount of from 10 to 35% by weight based on the total weight of the crème filling.

19. The process as recited in claim 15 wherein step a) comprises creaming with a stabilizing fat wherein the stabilizing fat is present in an amount of from 15 to 30% by weight based on the total weight of the crème filling.

20. The process as recited in claim 15 wherein step b) comprises adding the sweetener to the creamed stabilizer fat and omega-3 fatty acid mixture in an amount of from 40 to 85% by weight based on the total weight of the crème filling.

21. The process as recited in claim 15 wherein during steps a) and b) the crème filing is at a temperature of from 70 to 85° F.

22. The process as recited in claim 15 further comprising the step of adding to the creamed stabilizer fat and omega-3 fatty acid at least one emulsifier in an amount of from 0.05 to 2.0% by weight based on the total weight of the crème filling.

23. The process as recited in claim 15 wherein step a) comprises creaming at least one omega-3 fatty acid comprising eicosapentaenoic acid, docosahexaenoic acid, or a mixture thereof with a stabilizer fat having a saturated fat level of from 30 to 55% by weight and a trans-fat content of 1% or less.

24. The process as recited in claim 15 wherein step a) comprises creaming at least one omega-3 fatty acid comprising eicosapentaenoic acid, docosahexaenoic acid, or a mixture thereof with a stabilizer fat having a saturated fat level of from 30 to 55% by weight and wherein the level of DHA, or EPA, or both is from 1 to 13 milligrams per gram of crème filling.
